(19) United States
(12) Patent Application Publication
(10) Pub. No.: US 2026/0322251 A1
(43) Pub. Date: Oct. 15, 2026

(54) APPARATUS AND METHOD FOR CONTROLLING SWITCHING BETWEEN FREQUENCY CONVERTER AND POWER FREQUENCY BYPASS

(71) Applicant: SHENZHEN BEITONG CONTROL TECHNOLOGY CO., LTD., Guangdong (CN)

(72) Inventor: Tao CHENG, Guangdong (CN)

(73) Assignee: SHENZHEN BEITONG CONTROL TECHNOLOGY CO., LTD., Guangdong (CN)

(21) Appl. No.: 18/873,848

(22) PCT Filed: May 6, 2024
(86) PCT No.: PCT/CN2024/091100

§ 371 Date: Dec. 11, 2024

(30) Foreign Application Priority Data
Nov. 29, 2023 (CN) 202311614494.8

(51) Int. Cl. H02M 1/32; H02M 5/00

(52) U.S. Cl. CPC H02M 1/325; H02M 1/084; H02M 5/00; G06F 1/26; H02M 1/32

(57) ABSTRACT

An apparatus and a method for controlling switching between a frequency converter and a power frequency bypass are provided. The apparatus includes a controller: when it is detected that a fault signal is output by the frequency converter and the frequency converter is not successfully reset, determine to switch the frequency converter from a frequency conversion loop to a power frequency loop, and output a switching instruction for switching to the power frequency loop through a power frequency switching instruction output end; after it is detected that the fault signal is output by the frequency converter and the frequency converter is successfully reset, obtain a voltage of a to-be-detected power supply through a to-be-detected voltage input end, determine whether the voltage of the to-be-detected power supply has a dip change within a first preset time period before it is detected that the fault signal is output by the frequency converter.

### CROSS-REFERENCE TO RELATED APPLICATIONS

This application is a national stage application of International Patent Application No. PCT/CN2024/091100, filed on May 6, 2024, which claims priority to the Chinese Patent Application No. 202311614494.8, filed with the China National Intellectual Property Administration on Nov. 29, 2023, and entitled “APPARATUS AND METHOD FOR CONTROLLING SWITCHING BETWEEN FREQUENCY CONVERTER AND POWER FREQUENCY BYPASS”, which is incorporated herein by reference in its entirety.

### BACKGROUND OF THE INVENTION

### Field of the Invention

The present disclosure relates to the field of frequency converter technologies, and in particular, to an apparatus and a method for controlling switching between a frequency converter and a power frequency bypass.

### Description of the Related Art

A frequency converter is widely used in an industrial control system. As a power electronic product, the frequency converter is high in protection precision, and stops for protection due to threshold-crossing of various protection values in a use process. The frequency converter may stop for protection because of some faults of the frequency converter, some faults on a load side, and some transient faults on a power side. No matter which fault causes the frequency converter to stop, in some important working conditions, the frequency converter needs to continuously work without stop. The frequency converter usually has a power frequency loop, and is manually switched to the power frequency loop for operation while stopping due to a fault of the frequency converter. However, this still leads to forced interruption of production, and causes a specific production loss.

At present, a frequency conversion loop and a power frequency loop are manually switched. When the frequency converter has a fault, the fault needs to be manually determined. Only when it is determined that the fault is either a load-side fault or a fault of the frequency converter, the frequency converter is manually switched to power frequency startup. However, this causes a delay of restart time, and affects continuous production.

### BRIEF SUMMARY OF THE INVENTION

An objective of the present disclosure is to provide an apparatus and a method for controlling switching between a frequency converter and a power frequency bypass, to reduce impact on continuous production by automatically switching to a power frequency loop when the frequency converter has a fault.

To achieve the above objective, the present disclosure provides the following technical solutions.

An apparatus for controlling switching between a frequency converter and a power frequency bypass includes a controller, where the controller includes a to-be-detected voltage input end and a power frequency switching instruction output end, the to-be-detected voltage input end is connected to a to-be-detected power supply, and the power frequency switching instruction output end is configured to output a switching instruction for switching to a power frequency loop;
the controller is configured to: when it is detected that a fault signal is output by the frequency converter and the frequency converter is not successfully reset, determine to switch the frequency converter from a frequency conversion loop to the power frequency loop, and output the switching instruction for switching to the power frequency loop through the power frequency switching instruction output end; and
the controller is further configured to: after it is detected that the fault signal is output by the frequency converter and the frequency converter is successfully reset, obtain a voltage of the to-be-detected power supply through the to-be-detected voltage input end, and determine whether the voltage of the to-be-detected power supply has a dip change and a voltage dip reaches a preset value within a first preset time period before it is detected that the fault signal is output by the frequency converter; and if the voltage of the to-be-detected power supply has the dip change and the voltage dip reaches the preset value, determine to switch the frequency converter from the frequency conversion loop to the power frequency loop, and output the switching instruction for switching to the power frequency loop through the power frequency switching instruction output end.

Optionally, the controller further includes a frequency converter state signal input end, a frequency converter fault signal input end, and a reset pulse signal output end; the frequency converter state signal input end is configured to input a state signal of the frequency converter; the frequency converter fault signal input end is configured to receive the fault signal of the frequency converter; and the reset pulse signal output end is configured to send a reset pulse signal to the frequency converter;
the controller is further configured to:
detect, in real time through the frequency converter fault signal input end, whether the fault signal is output by the frequency converter;
send a reset pulse signal to the frequency converter through the reset pulse signal output end within a preset reset time period after it is detected that the fault signal is output by the frequency converter; and
determine whether the frequency converter is reset through the frequency converter state signal input end.

Optionally, after outputting the switching instruction for switching to the power frequency loop through the power frequency switching instruction output end, the controller is further configured to send an instruction for restarting the power frequency loop after a delay of second preset time.

Optionally, the controller further includes a voltage recording module of the to-be-detected power supply, and the voltage recording module of the to-be-detected power supply is configured to record a voltage at each moment of the to-be-detected power supply.

The present disclosure further discloses a method for switching between a frequency converter and a power frequency bypass, where the method for controlling switching between a frequency converter and a power frequency bypass is applied to the apparatus for controlling switching between a frequency converter and a power frequency bypass. The method for controlling switching between a frequency converter and a power frequency bypass includes:
when it is detected that a fault signal is output by the frequency converter and the frequency converter is not successfully reset, determining, by the controller, to switch the frequency converter from a frequency conversion loop to a power frequency loop, and outputting a switching instruction for switching to the power frequency loop through the power frequency switching instruction output end; and
after it is detected that the fault signal is output by the frequency converter and the frequency converter is successfully reset, obtaining, by the controller, a voltage of the to-be-detected power supply through the to-be-detected voltage input end, and determining whether the voltage of the to-be-detected power supply has a dip change and a voltage dip reaches a preset value within a first preset time period before it is detected that the fault signal is output by the frequency converter; and if the voltage of the to-be-detected power supply has the dip change and the voltage dip reaches the preset value, determining to switch the frequency converter from the frequency conversion loop to the power frequency loop, and outputting the switching instruction for switching to the power frequency loop through the power frequency switching instruction output end.

According to specific embodiments provided in the present disclosure, the present disclosure has the following technical effects:

The controller is configured to determine whether to switch the frequency converter from the frequency conversion loop to the power frequency loop based on a reset state of the frequency converter and a voltage change of the to-be-detected power supply, thereby implementing automatic switching to the power frequency loop when the frequency converter has a fault, and reducing impact on continuous production due to forced interruption of the production.

### BRIEF DESCRIPTION OF THE DRAWINGS

To describe embodiments of the present disclosure or technical solutions in the prior art more clearly, the accompanying drawings required in the embodiments are briefly introduced below. Obviously, the accompanying drawings described below are only some embodiments of the present disclosure. A person of ordinary skill in the art can also obtain other accompanying drawings according to these accompanying drawings without creative efforts.

FIG. 1 is a schematic diagram of a structure of an apparatus for controlling switching between a frequency converter and a power frequency bypass according to an embodiment of the present disclosure.

### DETAILED DESCRIPTION OF THE INVENTION

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

An objective of the present disclosure is to provide an apparatus and a method for controlling switching between a frequency converter and a power frequency bypass, to reduce impact on continuous production by automatically switching to a power frequency loop when the frequency converter has a fault.

In order to make the above objective, features and advantages of the present disclosure clearer and more comprehensible, the present disclosure will be further described in detail below in combination with accompanying drawings and particular implementations.

### Embodiment 1

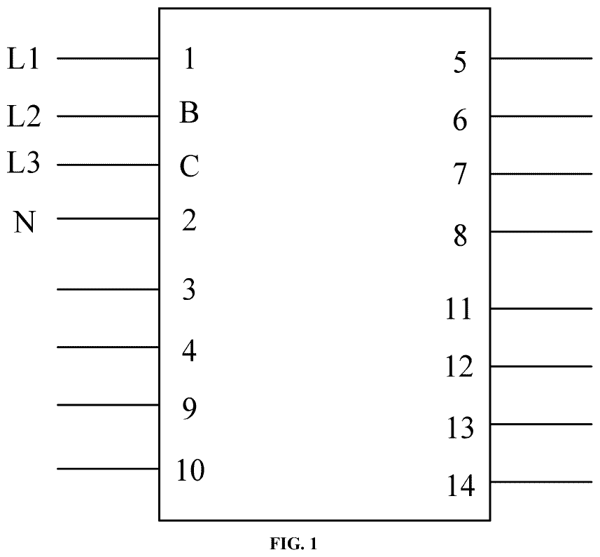

As shown in FIG. 1, according to the present disclosure, an apparatus for controlling switching between a frequency converter and a power frequency bypass includes a controller, where the controller includes a to-be-detected voltage input end, a frequency converter state signal input end, a frequency converter fault signal input end, a power frequency switching instruction output end, and a reset pulse signal output end. The to-be-detected voltage input end is connected to a to-be-detected power supply; the frequency converter state signal input end is configured to input a state signal of the frequency converter; the frequency converter fault signal input end is configured to receive a fault signal of the frequency converter; the reset pulse signal output end is configured to send a reset pulse signal to the frequency converter; and the power frequency switching instruction output end is configured to output a switching instruction for switching to a power frequency loop.

The frequency converter is separately connected to the to-be-detected power supply and a load. After frequency conversion is performed on a voltage of the to-be-detected power supply, the to-be-detected power supply supplies power to the load.

The controller is configured to:
when it is detected that the fault signal is output by the frequency converter and the frequency converter is not successfully reset, determine to switch the frequency converter from a frequency conversion loop to the power frequency loop, and output the switching instruction for switching to the power frequency loop through the power frequency switching instruction output end.

The controller is further configured to: after it is detected that the fault signal is output by the frequency converter and the frequency converter is successfully reset, obtain the voltage of the to-be-detected power supply through the to-be-detected voltage input end, determine whether the voltage of the to-be-detected power supply has a dip change and a voltage dip reaches a preset value within a first preset time period before it is detected that the fault signal is output by the frequency converter; if the voltage of the to-be-detected power supply has the dip change and the voltage dip reaches the preset value, determine to switch the frequency converter from the frequency conversion loop to the power frequency loop, output the switching instruction for switching to the power frequency loop through the power frequency switching instruction output end, and send an instruction of restarting the power frequency loop after a delay of second preset time; and if the voltage of the to-be-detected power supply has no dip change and the voltage dip does not reach the preset value, output no power frequency switching instruction and no instruction for restarting the power frequency loop.

The controller is further configured to:
Detect, in real time through the frequency converter fault signal input end, whether the fault signal is output by the frequency converter;
send a reset pulse signal to the frequency converter through the reset pulse signal output end within a preset reset time period after it is detected that the fault signal is output by the frequency converter; and
determine whether the frequency converter is reset through the frequency converter state signal input end.

If the frequency converter is successfully rest, it is determined whether the voltage of the to-be-detected power supply has the dip change and the voltage dip reaches a preset threshold within the first preset time period before it is detected that the fault signal is output by the frequency converter, and it is determined that the frequency converter is switched from the frequency conversion loop to the power frequency loop if the voltage of the to-be-detected power supply has the dip change and the voltage dip reaches the preset threshold.

The frequency converter is successfully reset, that is, no fault signal is output within the preset reset time period after the reset pulse signal is received by the frequency converter.

The frequency converter is not successfully reset, that is, a fault signal is still output within the preset reset time period after the reset pulse signal is received by the frequency converter.

Under a normal state, the power frequency loop of the frequency converter is disconnected.

If it is detected that the fault signal of the frequency converter is reset, and it is further determined that the voltage of the to-be-detected power supply has no dip change trend within the first preset time period before a change of the fault signal, no switching instruction and restart instruction are sent by the controller. The switching instruction is an instruction for switching the frequency converter to the power frequency loop, and the restart instruction is an instruction for starting the power frequency loop.

The controller further includes a voltage recording module of the to-be-detected power supply, and the voltage recording module of the to-be-detected power supply is configured to record a voltage at each moment of the to-be-detected power supply.

As shown in FIG. 1, the controller includes three-phase input terminals: L1, L2, and L3. A wiring terminal 1 and a wiring terminal 2 form a single-phase input end of the to-be-detected power supply. According to actual needs, the controller may be configured to detect a single-phase voltage, and may also be configured to detect a three-phase voltage.

When the voltage of the to-be-detected power supply is a single-phase voltage, the to-be-detected voltage input end includes the wiring terminal 1 and the wiring terminal 2.

When the voltage of the to-be-detected power supply is a three-phase voltage, the to-be-detected voltage input end includes the three-phase input terminals: L1, L2, and L3, namely, the wiring terminal 1, a wiring terminal B, and a wiring terminal C.

A wiring terminal 3 and a wiring terminal 4 form the frequency converter state signal input end for detecting an operation state of the frequency converter.

A wiring terminal 5 and a wiring terminal 6 are configured to output a start instruction (a restart instruction) for switching the frequency converter to the power frequency loop.

A wiring terminal 7 and a wiring terminal 8 form the power frequency switching instruction output end, and form a conversion switching line for switching between the frequency conversion loop and the power frequency loop.

A wiring terminal 9 and a wiring terminal 10 form the frequency converter fault signal input end.

A wiring terminal 11 and a wiring terminal 12 form the reset pulse signal output end for outputting a reset pulse signal to the frequency converter.

A wiring terminal 13 and a wiring terminal 14 are configured to output a state, that is, the wiring terminal 13 and the wiring terminal 14 are configured to output an operation signal in a process of switching the frequency converter to the power frequency loop.

Only one of the frequency conversion loop and the power frequency loop is connected. When the frequency conversion loop is connected, the power frequency loop is in a disconnected state. When the power frequency loop is connected, the frequency conversion loop is connected, and the two loops are in interlocked control. Therefore, when the switching instruction for switching to the power frequency loop is sent by the controller (specifically, the frequency conversion loop is switched to the power frequency loop via the wiring terminal 7 and the wiring terminal 8), an instruction for restarting the power frequency loop is sent after a delay of second preset time. Specifically, the power frequency loop is restarted via the wiring terminal 5 and the wiring terminal 6.

### Embodiment 2

The present disclosure further discloses a method for controlling switching between a frequency converter and a power frequency bypass, where the method for controlling switching between a frequency converter and a power frequency bypass is applied to the apparatus for controlling switching between a frequency converter and a power frequency bypass in Embodiment 1.

The method for controlling switching between a frequency converter and a power frequency bypass includes:
the controller is configured to: when it is detected that a fault signal is output by the frequency converter and the frequency converter is not successfully reset, determine to switch the frequency converter from a frequency conversion loop to a power frequency loop, and output a switching instruction for switching to the power frequency loop through the power frequency switching instruction output end.

The controller is configured to: after it is detected that the fault signal is output by the frequency converter and the frequency converter is successfully reset, obtain a voltage of the to-be-detected power supply through the to-be-detected voltage input end, and determine whether the voltage of the to-be-detected power supply has a dip change and a voltage dip reaches a preset value within a first preset time period before it is detected that the fault signal is output by the frequency converter; and if the voltage of the to-be-detected power supply has the dip change and the voltage dip reaches the preset value, determine to switch the frequency converter from the frequency conversion loop to the power frequency loop, and output the switching instruction for switching to the power frequency loop through the power frequency switching instruction output end.

Each embodiment in the description is described in a progressive mode, each embodiment focuses on differences from other embodiments, and references can be made to each other for the same and similar parts between embodiments.

Several examples are used for illustration of the principles and implementation methods of the present disclosure. The description of the examples is used to help illustrate the apparatus and its core concept in the present disclosure. In addition, those of ordinary skill in the art can make various modifications in terms of specific implementation methods and scope of application in accordance with the concept of the present disclosure. In conclusion, the content of the description shall not be construed as limitations to the present disclosure.

1. An apparatus for controlling switching between a frequency converter and a power frequency bypass, comprising a controller, wherein the controller comprises a to-be-detected voltage input end and a power frequency switching instruction output end, the to-be-detected voltage input end is connected to a to-be-detected power supply, and the power frequency switching instruction output end is configured to output a switching instruction for switching to a power frequency loop;
the controller is configured to: when it is detected that a fault signal is output by the frequency converter and the frequency converter is not successfully reset, determine to switch the frequency converter from a frequency conversion loop to the power frequency loop, and output the switching instruction for switching to the power frequency loop through the power frequency switching instruction output end; and
the controller is further configured to: after it is detected that the fault signal is output by the frequency converter and the frequency converter is successfully reset, obtain a voltage of the to-be-detected power supply through the to-be-detected voltage input end, and determine whether the voltage of the to-be-detected power supply has a dip change and a voltage dip reaches a preset value within a first preset time period before it is detected that the fault signal is output by the frequency converter; and if the voltage of the to-be-detected power supply has the dip change and the voltage dip reaches the preset value, determine to switch the frequency converter from the frequency conversion loop to the power frequency loop, and output the switching instruction for switching to the power frequency loop through the power frequency switching instruction output end.

2. The apparatus for controlling switching between a frequency converter and a power frequency bypass according to claim 1, wherein the controller further comprises a frequency converter state signal input end, a frequency converter fault signal input end, and a reset pulse signal output end; the frequency converter state signal input end is configured to input a state signal of the frequency converter; the frequency converter fault signal input end is configured to receive the fault signal of the frequency converter; and the reset pulse signal output end is configured to send a reset pulse signal to the frequency converter; and
the controller is further configured to:
detect in real time, through the frequency converter fault signal input end, whether the fault signal is output by the frequency converter;
send a reset pulse signal to the frequency converter through the reset pulse signal output end within the preset reset time period after it is detected that the fault signal is output by the frequency converter; and
determine whether the frequency converter is reset through the frequency converter state signal input end.

3. The apparatus for controlling switching between a frequency converter and a power frequency bypass according to claim 1, wherein after outputting the switching instruction for switching to the power frequency loop through the power frequency switching instruction output end, the controller is further configured to send an instruction of restarting the power frequency loop after a delay of second preset time.

4. The apparatus for controlling switching between a frequency converter and a power frequency bypass according to claim 1, wherein the controller further comprises a voltage recording module of the to-be-detected power supply, and the voltage recording module of the to-be-detected power supply is configured to record a voltage at each moment of the to-be-detected power supply.

5. A method for controlling switching between a frequency converter and a power frequency bypass, wherein the method for controlling switching between a frequency converter and a power frequency bypass is applied to the apparatus for controlling switching between a frequency converter and a power frequency bypass according to claim 1, wherein the method for controlling switching between a frequency converter and a power frequency bypass comprises:
when it is detected that a fault signal is output by the frequency converter and the frequency converter is not successfully reset, determining, by the controller, to switch the frequency converter from a frequency conversion loop to a power frequency loop, and outputting a switching instruction for switching to the power frequency loop through the power frequency switching instruction output end; and
after it is detected that the fault signal is output by the frequency converter and the frequency converter is successfully reset, obtaining, by the controller, a voltage of the to-be-detected power supply through the to-be-detected voltage input end, determining whether the voltage of the to-be-detected power supply has a dip change and a voltage dip reaches a preset value within a first preset time period before it is detected that the fault signal is output by the frequency converter; and if the voltage of the to-be-detected power supply has the dip change and the voltage dip reaches the preset value, determining to switch the frequency converter from the frequency conversion loop to the power frequency loop, and outputting the switching instruction for switching to the power frequency loop through the power frequency switching instruction output end.

6. The method according to claim 5, wherein the controller further comprises a frequency converter state signal input end, a frequency converter fault signal input end, and a reset pulse signal output end; the frequency converter state signal input end is configured to input a state signal of the frequency converter; the frequency converter fault signal input end is configured to receive the fault signal of the frequency converter; and the reset pulse signal output end is configured to send a reset pulse signal to the frequency converter; and
the controller is further configured to:
detect in real time, through the frequency converter fault signal input end, whether the fault signal is output by the frequency converter;
send a reset pulse signal to the frequency converter through the reset pulse signal output end within the preset reset time period after it is detected that the fault signal is output by the frequency converter; and
determine whether the frequency converter is reset through the frequency converter state signal input end.

7. The method according to claim 5, wherein after outputting the switching instruction for switching to the power frequency loop through the power frequency switching instruction output end, the controller is further configured to send an instruction of restarting the power frequency loop after a delay of second preset time.

8. The method according to claim 5, wherein the controller further comprises a voltage recording module of the to-be-detected power supply, and the voltage recording module of the to-be-detected power supply is configured to record a voltage at each moment of the to-be-detected power supply.
